(19) United States
(12) Patent Application Publication
(10) Pub. No.: US 2008/0189200 A1
(43) Pub. Date: Aug. 7, 2008

(54) DEGRESSIVE AUCTION METHOD

(76) Inventor: Sylvain Laurent Nicolas Bonfardin, Montpellier (FR)

Correspondence Address: SCHMEISER, OLSEN & WATTS, 22 CENTURY HILL DRIVE, SUITE 302, LATHAM, NY, 12110, US

(21) Appl. No.: 11/671,066

(22) Filed: Feb. 5, 2007

(51) Int. Cl. G06Q 30/00

(52) U.S. Cl. 705/37

(57) ABSTRACT

A degressive method for an auction process of the present invention comprises offering at least one item for sale; setting an initial maximum price, a minimum price and a degressive rule; receiving bidding from buyers, and a current price is decreased according to the degressive rule until the auction is ended. A degressive auction system comprises an input device for inputting an initial maximum price, a minimum price and a degressive rule; and a control device for receiving bidding from buyers, and the control device decreases the current price according to the degressive rule until the auction is terminated.

### BACKGROUND OF THE INVENTION

1. Field of the Invention

The invention relates to an auction method, particularly, this novel auction method features a maximum price and pre-determined time intervals, wherein the maximum price will be decreased after a period of time defined by the time intervals in order to reach the pre-set minimum price.

2. Description of the Related Art

In recent years, our society increasingly has to reply on computers and Internet, online sale is becoming more essential in everyday life. Auction for sale provides the fastest and most convenient way for the buyers around the world to shop easily and buy various goods within an instant. With the increasing demands of online auctions due to its popularity and success, various techniques have been developed to increase the utility and conveniences of the online sale applications in different areas, particular in online auction. The popularity of online auction is because it provides the excitement of competitions among bidders for the items offered for sale or purchase, it is a service not only available for individual purpose, many popular businesses use the online auction or marketplaces to buy and sell goods and services, often they can get great benefits and efficiencies as a result.

The current online auction method on the market, such as in the e-bay or yahoo online sale websites, the seller puts on a good for an auction including a starting price, a predetermined period in which the auction will be operated and a minimum buying price, wherein the minimum buying price is not disclosed to the public, or in some cases, sellers label a particular good “direct sale”, the buyers can bid or directly buy the item offered at the minimum price pre-set by the seller. Several problems can results from the current auction method: 1) the seller can only enjoy the maximum benefits when more than one bidder is competing for the same item and the product has to be sold to the highest bidder after the preset auction period; 2) a “buy now” action is operated during the auction and once it is triggered the auction will be terminated; 3) in both previous situation, the seller cannot be sure whether the sale has reached the maximum profit through the “richest buyer” after the auction period and after the “buy now” action. Therefore, in the conventional auction method, the deal is done under following conditions:
1. Time is up.
2. Last bidder has to reach the maximum auction price and the auction period would be ended.
3. once a “buy now” (at minimal price pre-set by user) action is triggered the auction would be ended.

The conventional system would choose the auction winner who offers the highest bidding price when the pre-set time is up, or in certain instants, the system would choose the auction winner whom is the last bidder to reach the maximum auction price. Although, this conventional auction method is commonly used in those famous commercial websites, such as e-bay and yahoo online sale, but there are some drawbacks in the conventional online auction system. First for all, the conventional online auction system is always taken place over a predetermined cycle of time in such that, the users of the auction (including buyers and the seller) can either bid directly on the website or contact with each other privately to settle the deal discreetly, once the secret deal, which normally cannot be seen or known by other users from the websites is closed between the buyer and the seller, then the auction process would be completed, it is, therefore, unfair and prejudice to other bidders who bid publicly through the system. Secondly, the buyers on the conventional auction system cannot see or know the minimal price of the product, in which the buyers cannot know the pre-set minimal price of the auction product, the auction might not be completed if all buyers bid below the minimal price resulting the deal cannot be completed, both buyers and the seller waste certain amount of time and money without closing the sale successfully. Thirdly, the benefits from the auction system can only be realized when more than one bidder is competing for the same good, and the good is sold to the highest bidder which exceed the pre-set minimum price, and the auction period has expired. However, in most instants, a lot of sellers in the conventional auction system cannot enjoy the great benefits because a lot of those bidding prices fail to reach the pre-set minimum prices or the auction is terminated before the bidding price can get to the highest bidder due to the time period expired. The seller is not sure whether the sale has reached quickly to the maximum profit.

### SUMMARY OF THE INVENTION

An object of the present invention is to provide an improved auction method which can resolve those problems in the conventional auction system and prevent any unnecessary private deal from occurring between the seller and the buyers, so that it will not jeopardize the fairness of the public auction without any discreet deals.

It is another object of the present invention is to provide an improved auction method which encourage competitions among the buyers to bid for the highest price, in such way, the seller can sell the item to the highest price quickly and effectively.

It is another object of the present invention to provide an improved auction method whereby a buyer can get the item(s) immediately, in such that, the seller can get the maximum price without much difficulty to close the sale, and no time and money are wasted on the auction process.

In order to achieve the above described objects, a degressive auction method of the present invention is provided comprising: offering at least one item for sale; setting a maximum price and a degressive rule; receiving and requesting bid from the buyers; decreasing the maximum price according to the degressive rule until the auction is terminated. A degressive auction system of the present invention comprises an input device for inputting an initial maximum and minimum price; a degressive rule; a control device for receiving bid from the buyers, wherein the control device decreases the initial maximum price/ current price according to the degressive rule until the auction is terminated. In other words, the auction would be ended when the user has bought the item offered either at a current price or when the auction period has elapsed.

Both the forgoing general description and the following detailed description are exemplary and explanatory only and are not restrictive of the invention, as claimed.

### BRIEF DESCRIPTION OF THE DRAWINGS

The accompanying drawings are included to provide a further understanding of the present invention, and are incorporated in and constitute a part of this specification. The drawings illustrate embodiments of the present invention and, together with the description, serve to explain the principles of the invention. In the drawings,

FIG. 1 is a processing flow diagram of a degressive auction method in accordance with a preferred embodiment of the present invention;

FIG. 2 is a processing flow diagram of determining auction parameters in accordance with a preferred embodiment of the present invention;

FIG. 3 is an auction action flow diagram of a degressive auction method in a accordance with a preferred embodiment of the present invention;

FIG. 4 is an auction action diagram of a degressive auction method in a accordance with a preferred embodiment of the present invention;

FIG. 5 is an auction action diagram of a degressive auction method in a accordance with a preferred embodiment of the present invention;

FIG. 6 is a system configuration diagram of a degressive auction system in a accordance with a preferred embodiment of the present invention.

### DETAILED DESCRIPTION OF THE PREFERRED EMBODIMENTS

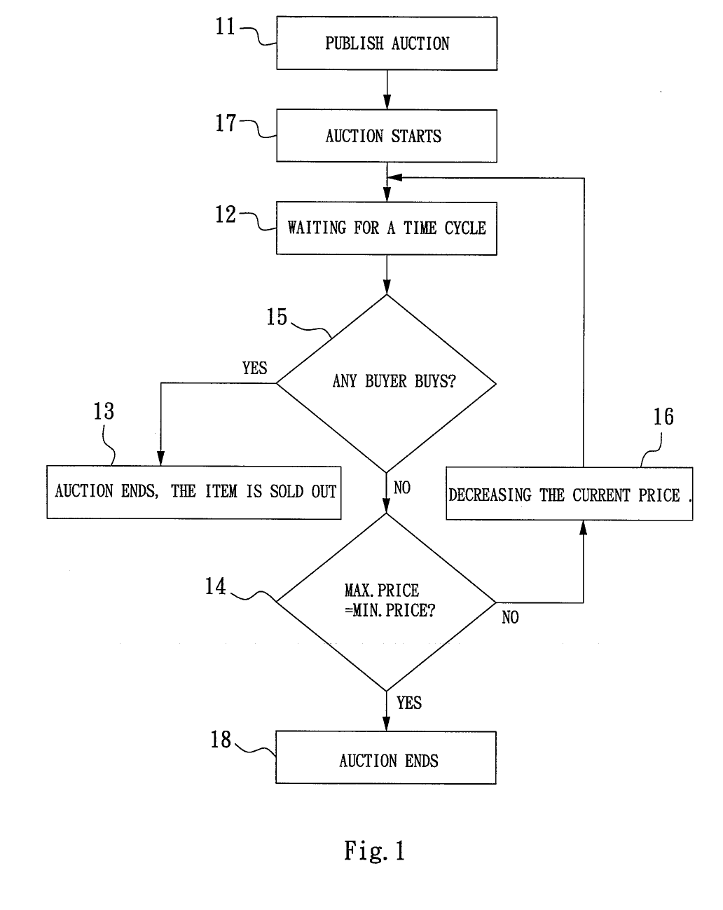

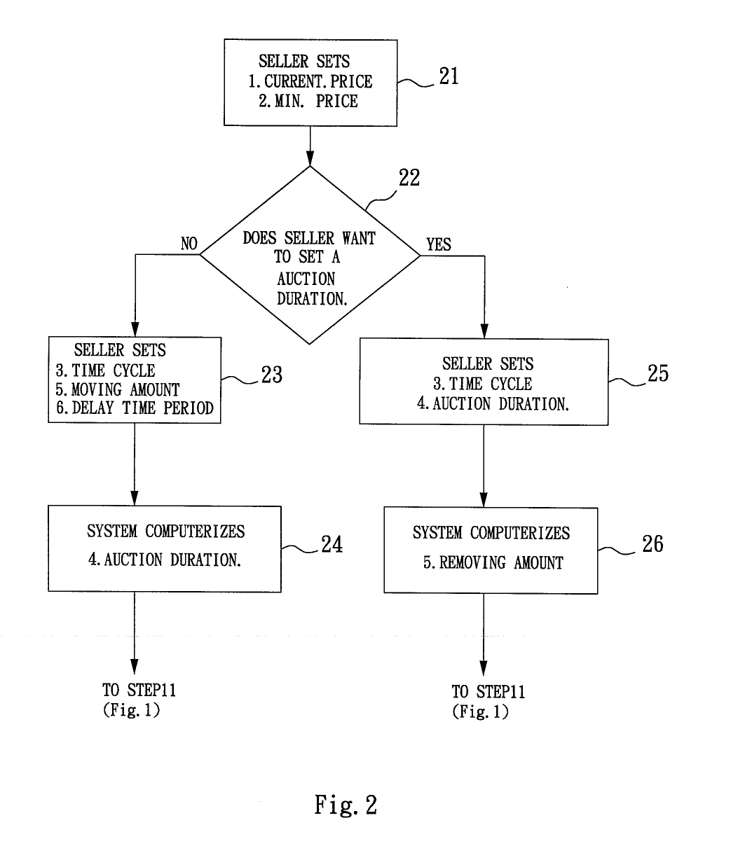

Before the present invention is described in greater details, it should be noted that same reference numerals have been used to denote like elements throughout the specification. FIG. 1 is a processing flow diagram of a degressive auction method in accordance with a preferred embodiment of the present invention. Initially, the seller publishes an auction for a product with a degressive rule in step 11 are pre-set, wherein the degressive rule comprises a maximum price, a minimum price, a time cycle, a predetermined auction duration and a removing amount. When the auction starts from step 17, the degressive auction system of the present invention will operate the auction according the predetermined value of the time cycle in step 12, and the maximum price of the auction product will be kept at the same amount without any alternation within the time cycle. Meanwhile, a buyer can bid, and if he decide to bid right away, then he is the winner of the auction and get the item at the current price, simultaneously, the system will start determining in step 15 in whether the bid offered from the buyer in step 12 is within the auction duration. If the bid offered by the buyer is within the auction duration, then the buyer who bids will become the winner of the auction, and auction will be terminated in step 13. However, if no buyer offers a bid within the auction duration, then the system will proceed to step 14, in which the system will check whether the current price is equaled to the minimum price. If the current price is equaled to the minimum price, it also means that the auction duration is elapsed, then the auction will be ended in step 18, as a result no bidding winner of the auction. But in step 14, if the current price is not yet reached to the pre-set minimum price set by the system, then the degressive auction system will proceed to step 16 to decrease the current price by removing a pre-set amount, in such so the degressive auction system will then start from step 12 again to proceed the rest of auction process.

Referring to FIG. 2, a processing flow diagram of determining auction parameters in a preferred embodiment of the present invention. At the beginning, a seller sets an initial maximum price and a minimum price in step 21. Once the pre-set values of the maximum price and the minimum price are inserted into the auction system, the system will ask if the seller wants to set an auction duration. If yes, the seller can sets a time cycle and an auction duration in step 25, and the system will computes a removing amount according to the inserted parameters which have been set up in step 26. The auction system proceeds to step 11 (in FIG. 1). However, if the seller does not wish to pre-set the auction duration in step 22, the seller can simply set a removing amount and a time cycle in step 23, and allow the auction system to compute an auction duration in step 24 for the seller. In other words, the auction duration of the auction can be either pre-set by the seller or pre-determined by the degressive auction system. Once the degressive auction system generates the predetermined auction duration of the auction, the auction system will proceed to step 11 of FIG. 1. It should be noticed that the processing flow diagram in FIG. 2 illustrates the auction method in accordance with one of preferred examples of the present invention to determine the auction parameters, the processing flow for determining the auction parameters of the present invention should not be restricted in this diagram.

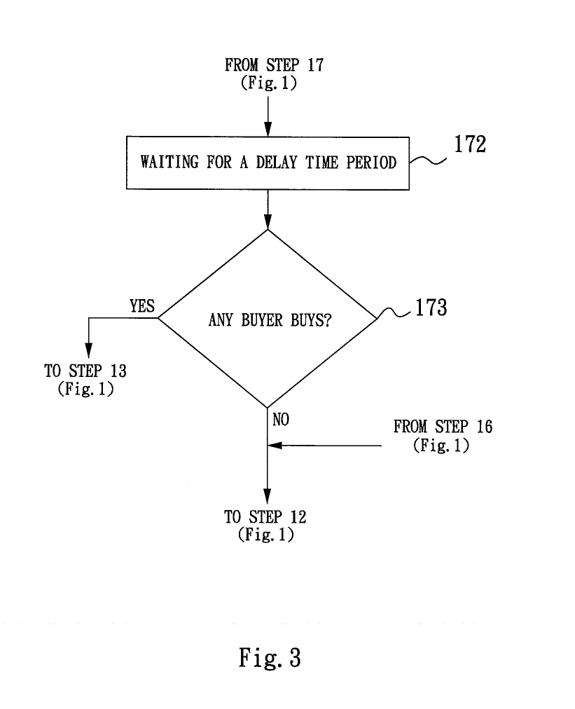

FIG. 3 provides a processing flow diagram between step 17 and step 12 of FIG. 1.The degressive auction parameters of the present invention further comprises a delay time period, wherein when the auction starts to kick off from step 17, the degressive auction system of the present invention will determine the pre-set delay time period in step 172 and proceed the auction process accordingly, and the maximum price of the auction product will be kept at the same amount without any change within the delay time period. Meanwhile, a buyer can bid on the good offered in the auction and get the good at the current price. If the bid offered by the buyer is within the auction duration of the auction, then the buyer will immediately become the winner of the auction, resulting the deal can be closed and the auction will be terminated in step 13 of FIG. 1. If there is no buyer or bidder to offer a bid on the item within the auction duration of the auction, then the system will proceed to step 12 of FIG. 1.

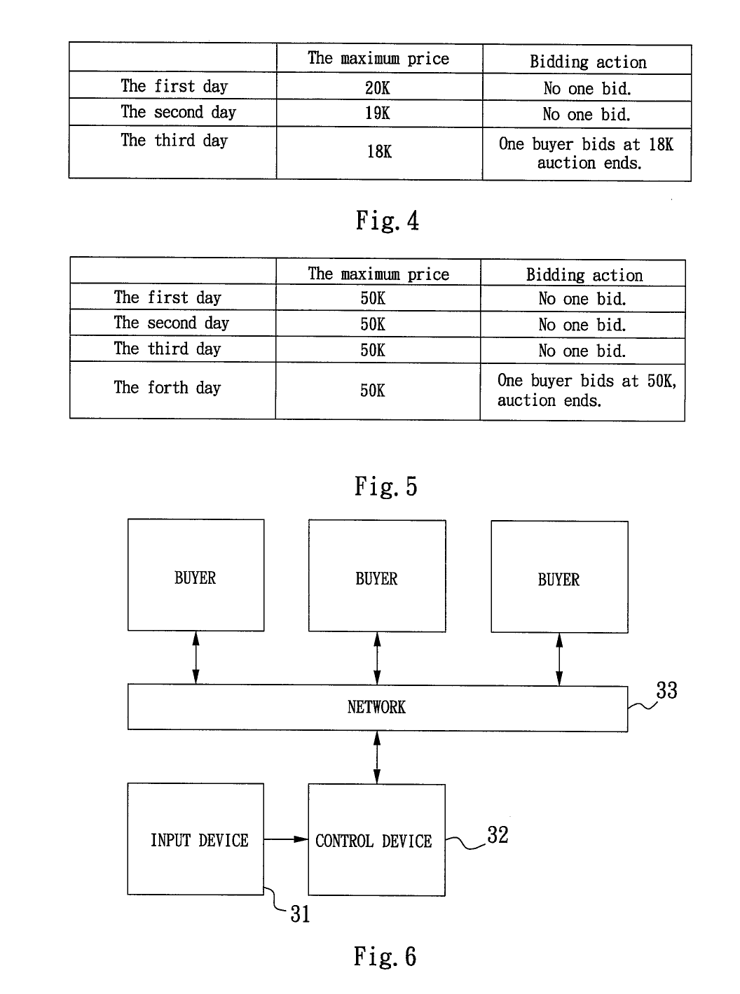

Referring to FIG. 4, an auction action diagram of a degressive auction method in accordance with a preferred embodiment of the present invention. And further referring to FIG. 1, FIG. 2 and FIG. 6. The seller can offer an item such as a car for sale on the Internet, wherein he sets an exaggerated maximum price of 20 thousand dollars and a minimum price of 15 thousand dollars into a control device 32 shown in FIG. 6 via an input device 31 (FIG. 6) in step 21 of FIG. 2. In such an instant, if the seller wishes to set an auction duration in step 22 of FIG. 2, he can set a time cycle of 1 day and an auction duration of 5 days in step 23. The control device 32 of FIG. 6 computes a removing amount of 1 thousand dollars in step 26 according to the parameters set above. After determining all the parameters, the control device 32 publishes the auction in step 11 of FIG. 1 via the network 33 of FIG. 6 so that every potential buyer or bidder will learn all the information of auction as described above. Once the auction starts in step 17, each bidder or potential buyer can start bidding at any moment, the auction will only be terminated when
1. a user bids on an item offered at a current price; and/or
2. the auction duration is elapsed or breached (i.e. when the current price is equaled to the minimum price).

For instant, when no one bids on the first day, in the beginning of the second day, the control device 32 will compute and update the current price as 19 thousand dollars which is a result from the original maximum price of 20 thousand dollars minus 1 thousand dollars (the pre-set removing amount) after 1 day (the pre-set time cycle). At the end of the second day, if no bid is offered, the degressive auction system will carry on decreasing the current price according to the pre-set parameters in such that at the beginning of the third day, the auction price will be 18 thousand dollars. Meanwhile, when a buyer bids then the auction will be terminated according to the above-mentioned condition 1 of the auction termination. When a user bids on the item offered at current price, the auction can be ended within a few days, the seller can sell the car with a price higher than the market price. In other words, the seller can sell the car to the high bidding price within a short period, as a result, the seller can enjoy a great profit, time and energy efficiencies of the auction. It is worth to be noticed that although the current price drops with certain amount according to the pre-set parameters, the seller will never lost his item's value since he already pre-set a minimum price which is normally higher than the item's market price.

Another example demonstrating the utilization of the present degressive auction system, a seller gets a bottle of wine for 800 dollars, and the retail price of the bottle of wine is 1000 dollars, in such, 12000 dollars for the 12 bottles of wine. The seller can utilize the degressive auction system by setting a maximum price of 11000 dollars, a removing amount of 5 dollars per day, and the minimum price of 9900 dollars. In such instant, the seller has the chance selling those wine higher than the retail price, and buyers also have the chance buying those wine lower than the retail price. Therefore, even when the seller does not sell the wine at its maximum price and the buyer actually buys the wine lower than the retail price, the seller still can make a profit because the pre-set minimum price of the wine is still higher than its original cost, thus, the seller will not lost his/her item's value without making a profit. In conclusion, every buyer can get auction information like the initial maximum price, the auction duration, the time cycle, and the pre-set minimum price, in such that, the buyer or the bidder can use those information to estimate and evaluate the item offered for auction in order to determine whether the auction price(s) and conditions are acceptable to them. If those information such as those conventional auction methods do not reveal to the buyer or the bidder, it is difficult for the buyer to determine whom are their competitors and what are those competitors' bidding prices. Without essential information provided to the buyers and bidders, even although when they know the minimum price of the auction item, but they still lack of enough information to evaluate whether the auction is suitable or acceptable for them to bid on. Unlike the conventional auction methods, the degressive auction method of the present invention provides all the necessary information for the buyer and bidder to determine whether the item is worthy for bidding, in such so, some buyers will not even wait until the current price to drop due to the popularity or rarity of the item offered. Since the auction system of the present invention allows the buyer and bidder to bid at any time once the auction is kicked off, the buyer can offer a high bidding price which could be equaled to the present price to disinterest other buyers or bidders. The degressive auction method and system of the present invention can let the buyers and sellers to save time and enjoy the most benefits.

Referring to FIG. 5, an action diagram of a degressive auction method in accordance with a preferred embodiment of the present invention. And further referring to FIG. 1, FIG. 2, FIG. 3 and FIG. 6. When a seller offers an unique signature ball, since such special item is hard to evaluate its actual marketing price, the seller can just set an enormous maximum price of 50 thousand dollars and a minimum price of 10 thousand dollars into the control device 32 of FIG. 6 via the input device 31 of FIG. 6 in step 21 of FIG. 2. If the seller does not want to pre-set an auction duration, he can just set a time cycle of 1 day and a removing amount of 5 thousand dollars in step 23. The seller determines a delay time period of the auction, such as 3 days, the control device 32 of FIG. 6 will compute an auction duration in step 24 according to the above pre-set parameters by the seller. After determining all the parameters, the control device 32 publishes the auction in step 11 of FIG. 1 via the network 33, in such that every potential buyer and bidder can know all the auction information as described-above. Once the auction starts in step 17 of FIG. 1, the first three days (from the first day to the third day), the maximum price will be kept at the same price of the initial maximum price of 50 thousand dollars in step 172 of FIG. 3. But, if there is no one bids in these three days, the control device 32 will determine the auction process and proceed continuously from step 173 of FIG. 3 to step 12 of FIG. 1. The current price will be kept at a price of 50 thousand dollars in the forth day in step 12. If there is one buyer bids on the current price of 50 thousand dollars, the control device 32 of the auction system proceeds the auction continuously from step 15 to step 13, once the buyer bids on item offered at a price of 50 thousand dollars in the forth day, in which the bidding price is equaled to the current price, then the auction process will be ended in step 13. While the present invention has been described in connection with what is considered the most practical and preferred embodiments, it should be understood that this invention is not limited to the disclosed embodiments. It is intended to cover various arrangements included within the spirit and scope of the broadest interpretations and equivalent arrangements.

What is claimed is:

1. A degressive auction method, comprising:
setting an initial maximum price, and a degressive rule either manually or
via a computerization of the auction method;
receiving a bid from buyers; and
decreasing a current price according to the degressive rule until the auction is terminated.

2. The degressive auction method of claim 1, wherein the degressive rule comprises an auction duration, a time cycle, a minimum price and a removing amount, the current price is decreased by subtracting the removing amount from the initial maximum price after the time cycle is elapsed until the auction is terminated.

3. The degressive auction method of claim 1, wherein the auction is terminated when a user bids on the current price.

4. The degressive auction method of claim 2, wherein the auction is terminated when the auction duration is breached.

5. The degressive auction method of claim 2, wherein the auction is terminated when the current price is equaled to the minimum price.

6. The degressive auction method of claim 1, wherein the bid further comprises a quantity of an item offered of the auction.

7. The degressive auction method of claim 2, wherein the minimum price is published publicly, therefore the buyers can know the minimum price before the auction process is started.

8. A system for conducting a degressive auction method, comprising:
an input device for inputting an initial maximum price and a degressive rule; and
a control device for receiving bidding information from buyers, wherein the control device decreases a current price according to the degressive rule until the auction is ended.

9. The degressive auction system of claim 9, wherein the degressive rule comprises an auction duration, a time cycle, a minimum price and a removing amount, the current price is decreased by subtracting the removing amount from the maximum price after the time cycle is elapsed, until the auction is terminated.

10. The degressive auction system of claim 9, wherein the auction is terminated when a user bids at the current price.

11. The degressive auction system of claim 10, wherein the auction is terminated when the auction duration is breached.

12. The degressive auction system of claim 10, wherein the condition of terminating the auction is when the current price is equaled to the minimum price.

13. The degressive auction system of claim 10, wherein the minimum price is published to the public, the buyers can know the minimum price before the auction starts.

14. The degressive auction system of claim 9, wherein a user can either set up the degressive rule: (1) by building up his own degressive rule manually; (2) by inputting a time cycle, a removing amount into the system and let the system computes an auction duration; or (3) by inputting a time period and a time cycle into the system, and let the system computes a removing amount.
